(19) United States
(12) Patent Application Publication
(10) Pub. No.: US 2015/0032541 A1
(43) Pub. Date: Jan. 29, 2015

(54) METHOD AND SYSTEM FOR ADVERTISING PREDICTION, IMPROVEMENT AND DISTRIBUTION

(71) Applicant: Pecabu, Inc., San Mateo, CA (US)

(72) Inventors: Rabih Haddad, Burlingame, CA (US); William Colwell, San Mateo, CA (US)

(73) Assignee: Pecabu, Inc., San Mateo, CA (US)

(21) Appl. No.: 14/337,729

(22) Filed: Jul. 22, 2014

Related U.S. Application Data
(60) Provisional application No. 61/857,880, filed on Jul. 24, 2013.

(51) Int. Cl. G06Q 30/02

(52) U.S. Cl. CPC G06Q 30/0259; G06Q 30/0269
USPC 705/14.57

(57) ABSTRACT

In some embodiments, a non-transitory processor-readable medium stores code representing instructions to be executed by a processor that causes the processor to receive historical demographic and historical environmental information associated with a geographic location and a recurring time period. The code causes the processor to select a first set of advertisements for the geographic location and the recurring time period based on the historical demographic and the historical environmental information. The code causes the processor to receive current demographic and current environmental information associated with the geographic location and a current time period associated with the recurring time period. The code causes the processor to send an instruction to present the first set of advertisements to a device at the geographical location and during the current time period if the current demographic and the current environmental information are substantially similar to the historical demographic and the historical environmental information.

### CROSS-REFERENCE TO RELATED APPLICATIONS

This application claims priority to and the benefit of U.S. Provisional Application Ser. No. 61/857,880, entitled “Method and System for Advertising, Prediction, Optimization and Distribution,” filed Jul. 24, 2013, which is incorporated herein by reference in its entirety.

This application is related to co-pending U.S. Non-Provisional Patent Application having Attorney Docket No. PECA-001/01US 320013-2005, filed on the same date, and entitled “Method and System for Demographic, Environmental, Business and/or Operational Information Collection and Processing”, which is incorporated herein by reference in its entirety.

### BACKGROUND

Some embodiments described herein relate generally to methods and apparatus for the improvement of advertising media according to a demographic, environmental and business information database to maximize relevance for viewers. In particular, but not by way of limitation, some of the embodiments described herein relate to methods and apparatus for demographic, environmental, and business data analysis and prediction as they relate to multiple advertising locations over time. More particularly, but not by way of limitation, some of the embodiments described herein relate to using demographic, environmental and business data to predict trends to deliver more relevant advertisement campaigns over a set of advertisement display devices.

Various known digital advertising media are used significantly and regularly in “real-world” or Out-Of-Home (OOH)/Digital Out-Of-Home (DOOH) advertising such as, for example, the widespread use of digital advertisement billboards, posters, and screens through light-emitting diode (LED) screen-based, liquid crystal display (LCD) screen-based, media and/or the like. In particular, in many urban areas such as Manhattan, Tokyo, London, digital advertising media has largely saturated the advertising market.

Known workflows in digital advertising media include manual or remote replacement of the content on advertisement screens on a periodic or substantially periodic basis (e.g., daily, weekly or monthly basis). In some known digital advertising methods, sales are typically done on a screen-by-screen/week-by-week basis, where an advertiser can contact the owner of a digital advertising enterprise or their representative (e.g., via telephone if the number is located somewhere on or near the advertising media in question) to negotiate a price for a period of usage on said media. The advertiser can subsequently send media to the digital advertising enterprise for presentation (e.g., display, output, play, broadcast, etc.). In some known digital advertising methods, the demographic, business and environmental factors at the advertising outlet are ignored. The advertisements are run at a specific outlet (e.g., a specific screen), over a given time period, for a fixed fee regardless of important factors such as, for example, the type of traffic (pedestrian vs. vehicular), the volume of traffic, demographic profile of viewers, weather, temperature, lighting, time of day, breaking news, and/or the like.

It is often desirable to determine the efficiency of advertising to guide efficient use of resources by comparing results of advertising at multiple locations, comparing the results of using different type of media in advertising, and more. This can affect allocating budgets for advertising. In some known advertising methods, however, little or no feedback mechanism is in place. Hence, advertisers seldom get the chance to review the efficacy of an advertisement using any related metric such as, for example, traffic analysis, direct sales results, viewer demographics, and/or the like.

Accordingly, a need exists for methods and apparatus for improving methods for delivering directed and relevant advertisements to a set of media locations based on predicted demographic, environmental, business and operational information.

### SUMMARY

In some embodiments, a non-transitory processor-readable medium stores code representing instructions to be executed by a processor that causes the processor to receive historical demographic information associated with a geographic location and a recurring time period, and historical environmental information associated with the geographic location and the recurring time period. The code also causes the processor to select a first set of advertisements for the geographic location and the recurring time period based on the historical demographic information and the historical environmental information. The code further causes the processor to receive current demographic information associated with the geographic location and a current time period that is associated with the recurring time period, and current environmental information associated with the geographic location and the current time period. In such embodiments, the code causes the processor to send an instruction to present the first set of advertisements to a device at the geographical location and during the current time period if (1) the current demographic information is substantially similar to the historical demographic information and (2) the current environmental information is substantially similar to the historical environmental information. In such embodiments, the code further causes the processor to send an instruction to present a second set of advertisements to a device at the geographic location and during the current time period if (1) the current demographic information is not substantially similar to the historical demographic information or (2) the current environmental information is not substantially similar to the historical environmental information.

### BRIEF DESCRIPTION OF THE DRAWINGS

FIG. 1 is a schematic illustration of the different components of a DEBO (measurement and prediction) system and external advertising applications, according to an embodiment.

FIG. 2 is a system block diagram of a central server, according to an embodiment.

FIG. 3 is a flowchart illustrating a method for determining the relevance of a particular advertisement campaign to a given set of current DEBO information, according to an embodiment.

FIG. 4 is a flowchart illustrating a method for charging an advertiser for presenting advertisement contents at a given geographical location per billing cycle, according to an embodiment.

FIG. 5 is a flowchart illustrating a method for providing a reward to a user of a mobile compute device for being within a pre-defined range of a given geographic location, according to an embodiment.

FIG. 6 is flowchart illustrating a method for calculating the relevance score between current DEBO information and target DEBO information to present an advertisement at a given geographic location, according to an embodiment.

### DETAILED DESCRIPTION

In some embodiments, a non-transitory processor-readable medium stores code representing instructions to be executed by a processor that causes the processor to receive historical demographic information associated with a geographic location and a recurring time period, and historical environmental information associated with the geographic location and the recurring time period. The code also causes the processor to select a first set of advertisements for the geographic location and the recurring time period based on the historical demographic information and the historical environmental information. The code further causes the processor to receive current demographic information associated with the geographic location and a current time period that is associated with the recurring time period, and current environmental information associated with the geographic location and the current time period. In such embodiments, the code causes the processor to send an instruction to present the first set of advertisements to a device at the geographical location and during the current time period if (1) the current demographic information is substantially similar to the historical demographic information and (2) the current environmental information is substantially similar to the historical environmental information. In such embodiments, the code further causes the processor to send an instruction to present a second set of advertisements to a device at the geographic location and during the current time period if (1) the current demographic information is not substantially similar to the historical demographic information or (2) the current environmental information is not substantially similar to the historical environmental information.

In some embodiments, a non-transitory processor-readable medium stores code representing instructions to be executed by a processor that causes the processor to receive target demographic information and target environmental information for an advertisement campaign. The code causes the processor to receive current demographic information and current environmental information for each geographic location from a set of geographic locations. The code also causes the processor to calculate for each geographic location from the set of geographic locations, a relevance score based on (1) a measure of relationship between the current demographic information for that geographic location and the target demographic information and (2) a measure of relationship between the current environmental information for that geographic location and the target environmental information. In such embodiments, the code also causes the processor to select to present (e.g., display, output, play, broadcast, etc.) an advertisement from the advertisement campaign at a geographic location from the set of geographic locations based on the relevance score for that geographic location meeting a criterion. The code further causes the processor to send an instruction to present (e.g., display, output, play, broadcast, etc.) the advertisement from the advertisement campaign to a device at the geographic location.

In some embodiments, an apparatus includes a campaign module implemented in at least one of a memory or a processing device that can receive target demographic information for an advertisement campaign. The apparatus also includes a historical information aggregation module that can receive and aggregate historical demographic information associated with a geographic location and a recurring time period. The apparatus further includes a current information module that can receive based on demographic information associated with a set of mobile compute devices within a pre-defined range of the geographic location during a current time period associated with the recurring time period, current demographic information associated with the geographic location and the current time period. In such embodiments, the apparatus also includes a relevance calculation module that is operatively coupled to the campaign module, the historical information aggregation module and the current information module. The relevance calculation module can calculate a relevance score based on a measure of relationship between (1) the current demographic information and the historical demographic information for the geographical location and the recurring time period, and (2) the target demographic information. In such embodiments, the apparatus also includes an advertisement selection module operatively coupled to the relevance calculation module that can send, based on the relevance score, an instruction to present (e.g., display, output, play, broadcast, etc.) an advertisement from the advertisement campaign to a device at the geographic location.

Collection of accurate data in regards to the movement and flow of demographic information within a geographic location is relevant to several fields including, but not limited to: advertising/marketing, urban planning, incentive/loyalty programs, social sciences and research in multiple fields. Additionally, the relationship between demographic information (or data) and environmental information (or data) such as, for example, weather, breaking news stories, noise levels, transit system information, is also relevant. As used herein, demographic, environmental, business and operational data is referred to as DEBO data.

Using DEBO data for selective advertising presents an opportunity to significantly enhance the efficiency of targeted “real-world” advertising. The (DEBO-type) database-based systems include a wealth of information that can be used for a variety of purposes such as, for example, advertising. The large volume of accurate and detailed information stored within the DEBO-type databases can be important in the rise of relevance in the “real-world” digital advertising market.

In some embodiments, a method and system includes delivering various advertisements to a set of digital out-of-home advertisement display devices (sometimes referred to as “DOOH media”). This is accomplished using an underlying DEBO-based system for prediction of DEBO data based on current data and historical trends. Furthermore, the relevance of an advertisement can be calculated by comparing marketing targets with predicted DEBO information at the specific DOOH geographic location.

As used herein, real-world advertising media (e.g., DOOH media) includes any digital media capable of output of video, audio, text, image, or any other electronic data for the purpose of advertising or information dissemination. Such media can include, for example, digital billboards, light emitting diode (LED)/Plasma/liquid crystal display (LCD) screens, small-format displays, projectors, cinema screens, televisions, loudspeaker systems, car audio systems, personal audio systems, radios, computer screens, mobile phone screens, tablets, multiple screens combined to form one large display, digital ink based posters, magazines, newspapers, and/or the like.

As used herein, an advertisement (sometimes referred to as “ad”) includes any media produced for the purpose of promoting a product, service or a special offer of any business, institution or individual. Such advertisements can include, for example, live action commercials, computer generated commercials, public service announcements, television ads, ads intended for the online distribution, radio advertisements, logos, promotional text offers, coupons, printed advertising media, posters, classified ads, and/or the like.

As used herein, demographic data includes, for example, any piece of information that can be connected to at least one personal attribute of an individual. Such data as they pertain to an individual or a group of individuals may include, for example, age, sex, physical attributes, marital status, income, feelings, moods, social network statuses, preferences, user Internet posts, Internet searches, purchases, physical characteristics, home address, employer and/or the like.

As used herein, environmental data includes, for example, any piece of information that can be connected to a specific geographic location at any point in time, or over a given time span. Such data may include, for example, temperature, wind direction, wind speed, number of people nearby (referred to as people count), number of vehicles nearby (referred to as car count), rain fall, pollution levels, allergen levels, ambient light, and/or the like.

As used herein, business data includes, for example, any piece of information that can be connected to the running of a business, group, corporation, individually owned company or partnership. Such data may include, for example, product stocks, sales figures, operating hours, financial data, sales targets, profit margins, employee data, customer data, and/or the like.

As used herein, operational data includes, for example, any piece of information that can be connected to a device or a service. Such data may include, for example, device status, operating temperature of device, rate of predicting, efficiency data, current load in device, errors, warnings, versions, number of connected users, and/or the like.

As used herein, relevant advertising includes, for example, any advertisement that is somehow directed, customized or optimized for the surrounding DEBO variables. For example, relevant advertising can refer to a warm-temperature vacation location ad that is presented when the temperature drops below a pre-determined level, a feminine hygiene product offering that is presented when a majority of viewers are women, a pop band song download offer presented when the average age of customers is below a certain pre-determined level, a muffin ad that is presented in a bakery until muffins are sold out upon which the advertisement display changes to ads for cookies, a generic ad that is customized with the nearest address to any given media display. Such relevant advertising can be used to deliver relevant outdoor digital advertising, relevant radio advertising, relevant mass transit advertising, relevant in-store advertising, relevant online advertising, and/or the like.

As used herein, predicted data includes, for example, any piece of DEBO information (or data) that is estimated or predicted based at least partially on historical DEBO trends. Such methods may include using calculations or algorithms such as lasso and elastic-net regularized generalized linear models and/or ensembles of decision trees (random forests).

As used herein, a module can be, for example, any assembly and/or set of operatively-coupled electrical components associated with performing a specific function(s), and can include, for example, a memory, a processor, electrical traces, optical connectors, software (that is stored in memory and/or executing in hardware) and/or the like.

As used herein, a user can be, for example, any person that is using a mobile compute device on which an application is installed that can transmit user demographic, location and time information to a central server. Moreover, used in this specification, a user may or may not be the owner of the mobile compute device.

As used herein, target data can be, for example, any set of demographic, environmental or business goals associated with an advertisement campaign, such as sex, age, income, marital status, sales figures, weather information, stock quantities, and/or the like.

As used herein, “real-world advertising media” can be, for example, any media capable of presenting an advertisement (e.g., as a physical manifestation), such as a billboard, an LED screen, an LCD screen, a speaker, a poster, a magazine, an in-store placard, a sign, a computer screen, a television (TV) screen, mass transit advertising, in store advertising, and/or the like.

As used herein, “outputting relevant advertisements in a number of formats” can include outputting video data as a stream or pre-recording, outputting audio as a stream or pre-recording, outputting advertising as a video stream or image or audio file, a text file to be presented, an executable computer file using any of a number of wired and wireless protocols, and/or the like.

As used herein, “predict current demographic, environmental and business information” can include sending a request for information at a certain geographic location at a given time, receiving both historical and current information from the underlying data platform, parsing historical data into numerous relevant subsets, setting a weight to each subset, and calculating predicted current and future demographic, environmental and business data accordingly, and/or the like.

As used herein, “registering and defining a set of real-world advertisement campaigns with associated target data” can describe an advertiser using an online portal to upload advertising content, associate the advertising content with target demographic, environmental and business data, and setting an appropriate budget, and/or the like.

As used herein, the term “social media” refers to, for example, online social networks that build online communities of people, who share interests and/or activities, or who are interested in exploring the interests and activities of others. Most social media services are web-based and provide a variety of ways for users to interact such as, for example, via electronic maim (email), file sharing, instant messaging services, and/or the like. Examples of some social media platforms include, but are not limited to, Facebook, Twitter, Yelp, and so forth.

As used in this specification, the singular forms “a,” “an” and “the” include plural referents unless the context clearly dictates otherwise. Thus, for example, the term “a central server” is intended to mean a single central server or a combination of central servers.

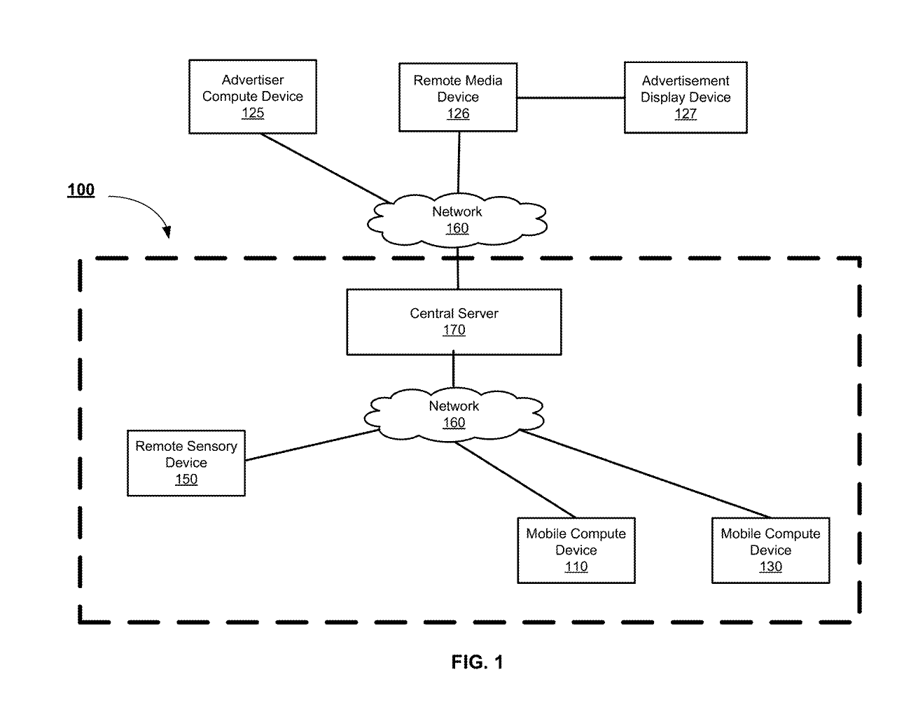

FIG. 1 is a schematic illustration of the different components of a DEBO (measurement and prediction) system and external advertising applications, according to an embodiment. The different components of the DEBO system are contained within the dashed box 100. The DEBO system 100 can collect and process demographic, environmental, business and operational data from a set of geographical locations using a set of sensors and inputs. The information from the DEBO system 100 can be accessed (e.g., repeatedly, regularly or substantially regularly) by external devices and systems such as, for example, the advertiser compute device 125 for DEBO information-based predictions and calculations of relevance scores to improve or optimize the efficacy of advertisement campaigns.

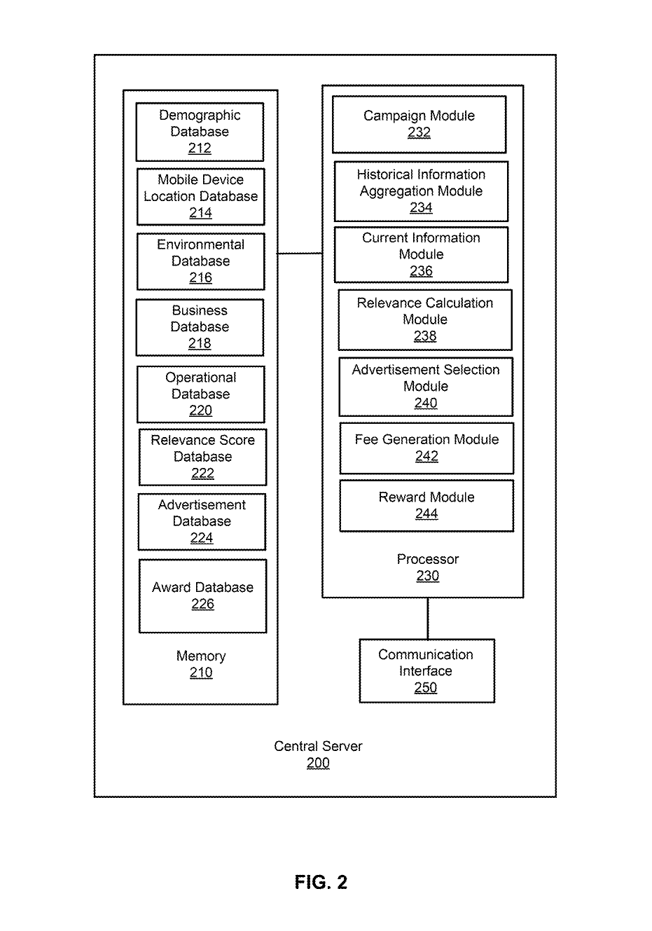

FIG. 1 illustrates a central server 170 operatively coupled with other devices. For example, the central server 170 is operatively coupled to two mobile compute devices 110 and 130 and at least one remote sensory device 150. FIG. 1 shows the central server 170 operatively coupled to two mobile compute devices 110 and 130 and one remote sensory device 150 as an example only, and not a limitation. In other configurations, the central server 170 can be operatively coupled to more than two mobile compute devices and more than one (i.e., multiple) remote sensory device. In some configurations, the connections between the central server 170 and the other devices can be direct, via a network 160 (e.g., the Internet), using a wireless protocol, a wired protocol, and/or a mixture of wired and wireless protocols. Furthermore, the architecture and/or hardware depicted and described with respect to FIG. 1 can be used in the embodiments and methods shown and described herein with respect to FIGS. 2-6. For example, the central server 170 shown and described with respect to FIG. 1 can be the similar to the central server shown and described in relation to FIG. 2. The network 160 can be any type of network (e.g., a local area network (LAN), a wide area network (WAN), a virtual network, and/or a telecommunications network) implemented as a wired network and/or a wireless network and can include an intranet, an Internet Service Provider (ISP) and the Internet, a cellular network, and/or the like.

In FIG. 1 and as used herein, mobile compute devices 110 and 130 can include any device that can be used by an individual or a user to perform computation and/or to communicate with other devices. Such mobile compute devices can be portable and can include a communication element and a processing element. The mobile compute devices 110 and 130 can be, for example, smart phones, cellular phones, laptop computers, tablets, desktop computers, web-enabled appliances vehicles with internet capabilities, and/or the like.

Demographic data can be collected by a set of mobile compute devices 110 and 130 (i.e., personal devices) and transmitted repeatedly, regularly or substantially regularly back to the central server 170 via the network 160 (e.g., an Internet connection) to establish a demographic presence at a specific geographic location (or geographic area) at a given or recurring time periods. In some instances, some environmental data such as, for example, the local temperature, the ambient light levels, and so forth can also be collected by mobile compute devices 110 and 130 and transmitted to the central server 170.

In FIG. 1 and as used herein, a remote sensory device 150 (sometimes referred to herein as an “RSD”) can include any device that can sense the surrounding environment and can communicate that information over the network 160 (e.g., the Internet). Such devices are typically stationary and can include communication elements, sensory elements, and/or a processing element. Such devices can record a range of environmental data through a series of sensors (also referred to as a sensor array). Additionally, such remote sensory devices 150 can communicate with the central server 170 through any number of wireless protocols. The wireless protocols may include, for example, cellular networks, Wi-Fi®, WIMAX, in any current or future versions, and/or the like.

In the embodiment of the DEBO system illustrated in FIG. 1, the RSD 150 can collect environmental data at various geographic locations throughout a given geographic area (e.g., city, state, country, globally, etc.). Environmental data can be collected by the RSD 150 using sensor or sensor arrays that can be either directly mounted to the RSDs 150 and/or operably coupled to the RSDs 150. Such sensor arrays can include, for example, cameras, microphones, weather sensors, and/or the like. Such sensors can measure current weather data and sound data, as well as use cameras to count and measure the number of people and vehicles in a pre-determined vicinity of the RSD 150. The resulting environmental data can be accumulated and compressed into a data packet or a stream of data packet by the RSD 150 and transmitted to the central server 170 for storage and further processing. The remote sensory device is described in greater detail in U.S. Non-Provisional Patent Application having Attorney Docket No. PECA-001/01US 320013-2005, which is incorporated herein by reference in its entirety.

In FIG. 1 and as used herein, the central server 170 includes, for example, any server or cloud-based device that can store, compute or communicate data. The central server 170 can be typically stationary and can have storage elements, communication elements and processing elements. The central server 170 can be connected to the network 160 (e.g., the Internet) via high speed connections such as, for example, T-level connections, fiber optics connections, and/or the like. In some instances, business data can be collected directly by the central server 170. In such instances, periodic queries, with parameters defined by the business owner, can be sent from the central server 170 to a business database via the network 160 (e.g., over the Internet). The query results can be sorted by geographical location and business metric, and can be sent to the central server 170 for storage and further processing. In some instances, operational data can also be collected directly by the central server 170. In such instances, periodic requests for sensor readings can be sent by the central server 170 to a wide range of sensors designed to give operational feedback over the network 160 (e.g., the Internet). The resulting operational data obtained by the central server 170 can be sorted by geographical location and data type (e.g., Boolean, counter, float, text, etc.) and stored in the central server 170. The method for collection of business data and operational data by the central server 170 is described in greater detail in U.S. Non-Provisional Patent Application having Attorney Docket No. PECA-001/01US 320013-2005, which is incorporated herein by reference in its entirety.

The central server 170 can collect and organize the demographic, environmental, business and operational (DEBO) data into multiple databases (not shown in FIG. 1). The central server 170 can implement various correlation methods to correlate the different kinds of DEBO data associated with a specific geographic area and a given time period to generate and/or define a trend associated with that geographic area at a given time period. Such trends can also be stored in databases on or accessible by the central server 170, where such (historical) trends can be used to predict a future trend in that geographical area by the central server 170. The different kinds of DEBO data stored in the different databases can be queried by a variety of external entities such as the advertiser compute device 125 for predictive use. Such external entities or applications can be, for example, advertising entities, research institutions, business research, marketing planners and strategists, urban planners, news networks, and/or the like.

The central server 170 can receive historical demographic data associated with a geographic location and a recurring time period, and historical environmental information associated with the geographic location and the recurring time period. Such historical demographic data can be received from the mobile compute devices 110 and 130 and/or retrieved from one or multiple databases stored in the central server 170 and/or operatively coupled to the central server 170. The central server 170 can store a set of advertisements from various third-party entities (e.g., advertiser compute device 125) in a database stored in the central server 170. The central server 170 can also select a first set of advertisements for the geographic location and the recurring time period based on the historical demographic data and the historical environmental information. The central server 170 can receive current demographic information (or data) associated with the geographic location and a current time period associated with the recurring time period from the mobile compute devices 110 and 130. The central server 170 can receive current environmental information (or data) associated with the geographic location and the current time period from the remote sensory device 150.

The central server 170 can receive target demographic information and target environmental information from the advertiser compute device 125, and can store the target demographic information, and target environmental information in a database (not shown in FIG. 1). The central server 170 can calculate a relevance score based on a measure of the relationship between the current environmental information, the historical environmental information, and the target environmental information for a given geographic location and the recurring time period. The central server 170 can also calculate a relevance score based on a measure of the relationship between the current demographic information, the historical demographic information, and/or the target demographic information for a given geographic location and the recurring time period.

In some instances, the central server 170 can send a signal representing instructions to present a first set of advertisements to the remote media device 126 at the geographic location and during the current time period if the current demographic information is substantially similar to the historical demographic information and the current environmental information is substantially similar to the historical environmental information. For example, in some instances, the current demographic information can be substantially similar to the historical demographic information and/or the current environmental information can be substantially similar to the historical environmental information if a relevance score (or relevance value) calculated by the central server 170 based on a measure of a relationship between the current demographic information and the historical demographic information (or between the current environmental information and the historical environmental information) is above a predetermined value, within a predetermined range of values and/or meets a predetermined criterion. In some embodiments, the first set of advertisements can be preselected based on the target information for the first set of advertisements being relevant (e.g., based on a relevance score) to the historical information (e.g., demographic and environmental). In such embodiments, the first set of advertisements can be sent from the central server 170 to the remote media device 126 such that the remote media device 126 stores the first set of advertisements prior to presenting the first set of advertisements.

In other instances, the central server 170 can send a signal representing instructions to present a second set of advertisements (e.g., a default set of advertisements and/or more relevant set of advertisements than the first set of advertisements) to the remote media device 126 at the geographic location and during the current time if the current demographic information is not substantially similar to the historical demographic information and/or the current environmental information is not substantially similar to the historical environmental information. For example, in some instances, the current demographic information can be not substantially similar to the historical demographic information and/or the current environmental information can be not substantially similar to the historical environmental information if a relevance score (or relevance value) calculated by the central server 170 based on a measure of a relationship between the current demographic information and the historical demographic information (or between the current environmental information and the historical environmental information) is below a predetermined value, outside a predetermined range of values and/or does not meet a predetermined criterion. The relevance score calculations and the central server 170 are discussed in greater detail below in relation to FIG. 2. Such a second set of advertisements can be stored at the central server 170 and/or the remote media device 126 and can be presented when the current information is not substantially similar to the historical information.

The advertiser compute device 125 can be a compute device (e.g., a server, a desktop computer, a laptop computer, etc.) associated with an advertiser. An advertiser is a customer of the DEBO system 100 and can be, for example, a business, an organization, an institution or an individual with the desire or intent to distribute relevant marketing information to a subset of the general public. For example, advertisers can include government institutions or programs, for-profit businesses, non-profit businesses, educational/scientific institutions, individuals, communities, and/or the like. The advertiser compute device 125 can be operably coupled to the central server 170 via, for example, an “online portal”, which can be a website allowing the advertiser to manipulate their advertising campaigns remotely over the network 160 (e.g., the Internet). The advertiser compute device 125 includes a memory and a processor (not shown in FIG. 1). In some instances, the advertiser compute device 125 can define an advertisement campaign by uploading an advertisement content (or media) such as an image file, a video file or a sound file to the central server 170, generating the associated target DEBO parameters for the advertisement content, and associating a budget for the advertisement content. Note that FIG. 1 shows one advertiser compute device 125 operably coupled to the central server 170 as an example only, and not a limitation. In other configurations multiple advertiser compute devices (i.e., multiple customers of the DEBO system 100) can be coupled to the central server 170. In such configurations, multiple customers of the DEBO system 100 can load their individual advertising contents to the central server 170. The advertiser compute device 125 can also add the target DEBO parameters (e.g., target demographic information, target environmental information, etc.) for the advertising content to define the target audience, environment and business parameters. The uploaded advertising content and target DEBO parameters can be stored in a database in the central server 170 (not shown in FIG. 1).

In FIG. 1, the remote media device 126 (sometimes referred to herein as a “RMD”) is a device that can facilitate or present advertisements on any kind of advertisement display devices 127 (e.g., DOOH displays) and communicate information over the network 160 (e.g., the Internet) to the central server 170. The RMD can include a memory and a processor (not shown in FIG. 1). In some instances, the RMD 126 can be stationary in relation to the advertisement display device 127 and can have both communication and media display elements as well as a processing element. In some instances, the RMD 126 can directly output or present the advertisement content sent from the central server 170 through a set of protocols, such as High-Definition Multimedia Interface (HDMI)®, Video Graphics Array (VGA), Digital Visual Interface (DVI), Ethernet, 3.5 mm jack, stereo connection, mono connection, and/or the like. In other instances, the RMD 126 can be operably coupled to one or multiple advertisement display devices 127 and can send a signal representing the advertisement content and instructions to present the advertisement content to such advertisement display device(s) 127 that can be, for example, digital advertisement billboards, posters, and screens that use light-emitting diode (LED) screen-based, liquid crystal display (LCD) screen-based, audio outputs, and/or the like. Additionally, the RMD 126 can communicate with the central server 170 for new advertisement content, feedback, maintenance, and so forth through a number of protocols such as, for example, Cellular data networks, Bluetooth™, Wireless Fidelity (Wi-Fi)™, Radio-Frequency Identification (RFID), wired Ethernet, and/or the like.

In some instances, the advertisement display device 127 can be, for example, devices associated with “real-world” or Out-Of-Home (OOH)/Digital Out-Of-Home (DOOH) advertising such as, for example, digital advertisement billboards, posters, and screens that use light-emitting diode (LED) screen-based, liquid crystal display (LCD) screen-based, audio outputs like radio broadcasting towers and/or the like. In other instances, the advertisement display device 127 can be, for example, smart phones, cellular phones, laptop computers, tablets, desktop computers, web-enabled appliances vehicles with internet capabilities, television sets, and/or the like. The advertisement display device 127 can include a display unit (not shown in FIG. 1). The display unit can be, for example, a liquid crystal display (LCD) unit or a light emitting diode (LED) alpha-numeric display unit that can present the advertisement content sent from the remote media device 126 and/or the central server 170. The advertisement display device 127 at a geographic location can receive individual advertising contents (e.g., an image file, a video file or a sound file) from the remote media device 126 and present the advertising content at given time period or a current time period that is associated with the recurring time period.

In some instances, the advertiser compute device 125 can define the target DEBO parameters associated with a specific advertising content and can upload an advertisement campaign (defined as the advertising content with the target DEBO parameters and the associated budget) to a database in the central server 170. Such target DEBO parameters can include, for example, a target age range, a target income bracket, a target sex of individuals, a target marital status of individuals, a target location, a target weather condition, a target time of day, sales, stocks, and/or the like. Additionally, the advertiser compute device 125 can also set a budget for a given time period and a given geographic location (or geographic area) for the set the advertising campaigns associated with the advertiser compute device 125 stored at the central server 170.

In such instances, advertisement campaigns can be processed in the central server 170 such that a filtration method can be implemented to determine the most relevant advertisements stored in the central server 170 that are specific to an advertising display device 127 at a specific geographic location at a given time period. Such filtration methods can be based on, for example, relevance scores computed as described above. In such instances, advertisement campaigns that do not have a positive balance in their budget can be removed from consideration. The set of target DEBO information (or parameters), current DEBO information (or parameters) and historical DEBO information (or parameters) can then pass through a series of evaluations at the central server 170. For example, the current DEBO information can be compared with historical DEBO information to determine if the current DEBO information differs substantially from the historical DEBO information. If so, the central server 170 can make the determination an anomaly is occurring at the given geographic location such as, for example, an event, concert, show, gathering, exhibition, and thus the central server 170 can weigh the current DEBO information more heavily than the historical DEBO information at the given geographic location.

The current DEBO information can then be compared, in no particular order, to the target DEBO information of the different advertisement campaigns to find the best match. For example, current DEBO information such as, for example, the time of day, predicted age group and current sales figures for a particular day can be weighed against target DEBO information for a large number of advertisement campaigns to determine the most relevant subset of advertisement campaigns within a given group of advertisement campaigns. Advertisement contents associated with the advertisement campaigns with the highest relevance scores are sent to the corresponding RMD 126 from the central server 170. Depending on their relevance score, such advertisement contents can displace other existing advertisement contents in, for example, a local advertisement registry or database in the RMD 126. A central processor (or distributor module) in the RMD 126 can send the appropriate advertisement contents to one or a set of advertisement display devices 127 (e.g., players and/or display devices) that can each present (e.g., output, play and/or display) the advertisement content on a single or a set of output mediums (e.g., audio output devices, screens, etc.). For example, such advertisement display devices 127 can include the players and screens of the DOOH advertising media. In some instances, frequently played advertisement contents can be downgraded in relevance, for a given period of time, so that other advertisement contents can be presented (e.g., displayed).

FIG. 2 is a system block diagram of a central server, according to an embodiment. The central server 200 is similar to the central server 170 shown in FIG. 1. The central server 200 can be, for example, any server or cloud-based device that can be used by an enterprise (e.g., a company), an individual or a group of individuals to store, compute or communicate data. The central server 200 can be stationary and can have storage elements, communication elements and processing elements. The central server 200 can include one or more components, for example, rack mounted servers, tower servers, blade servers, mainframes, computing clusters, cloud computing services, cloud storage services, storage arrays, redundant array of independent disks (RAID) storage arrays, and/or the like. The central server 200 can be connected to the Internet via high speed connections such as T-level connections, fiber optics, and/or the like. The central server can 200 organize and collate the demographic, environmental, business and operational data into multiple databases 212-220 as described in greater detail herein. The databases 212-226 can be queried by a variety of external applications for use. Such external applications can be for, for example, advertising applications, research institutions, business research, marketing planners and strategists, urban planners, news networks, and/or the like.

The central server 200 includes a memory 210, a processor 230 and a communication interface 250. The memory 210 can be, for example, a random access memory (RAM), a memory buffer, a hard drive, a database, an erasable programmable read-only memory (EPROM), an electrically erasable read-only memory (EEPROM), a read-only memory (ROM) and/or so forth. The memory 210 can store instructions to cause the processor 230 to execute modules, processes and/or functions associated with the central server 200 and/or the DEBO measurement system (e.g., DEBO system 100 as shown in FIG. 1). The memory 210 includes a demographic database 212, a mobile device location database 214, an environmental database 216, a business database 218, an operational database 220, a relevance score database 222, an advertisement database 224, and an award database 226.

The demographic database 212 can be a lookup table or a dedicated memory space that can store demographic information (both current and historical) of users associated with the set of mobile compute devices in multiple geographical areas and any time period that can be associated with a recurring time period. Examples of demographical information can include photographs of users, infra-red facial profile of users, retinal scan images users, fingerprint scan images of users, user name, user date of birth, user marital status, user sex, user income levels, user address, social media information, preferences, social network information (e.g., posts, comments, etc.), family information, and/or the like. The information stored in the demographic database 212 can be updated by the processor 230 whenever new data is available. The information stored in the demographic database 212 can be accessed by the historical information aggregation module 234, the current information module 236 and the relevance calculation module 238 to calculate a relevance score based on a measure of the relationship between the current demographic information and the historical demographic information for a given geographic location and the recurring time period (or a specific time period) and the target demographic information.

The mobile device location database 214 can be a lookup table or a dedicated memory space that can store location data (both current and historical) obtained from the set of mobile compute devices such as, for example, latitude, longitude, global positioning system (GPS) coordinates, street address, zip code, and/or the like. The mobile device location database 214 can also store time data for a time associated with the location of different mobile compute devices such as, for example, time zone, timestamp, daylight savings time (in hours, minutes, seconds), and/or the like. The information stored in the mobile device location database 214 can be updated by the processor 230 whenever new data is available.

The environmental database 216 can be a lookup table or a dedicated memory space that can store environmental information received from one or multiple remote sensory devices located in different geographic locations or geographic areas (e.g., remote sensory device 150 in FIG. 1). Examples of such environmental information (or data) can include, for example, the temperature, the ambient light level, the barometric pressure, the rain fall, the pollution, the air quality, allergens, radioactivity, wind speed, wind direction, water levels, noise levels, the number of people and/or vehicles in a given vicinity of the remote sensory device, and/or the like. The information (or data) stored in the environmental database 216 can be updated by the processor 230 whenever new data is available. The information stored in the environmental database 216 can be accessed by the historical information aggregation module 234, the current information module 236 and the relevance calculation module 238 to calculate a relevance score based on a measure of the relationship between the current environmental information and the historical environmental information for a given geographic location and a recurring time period (or a specific time period) and the target environmental information.

The business database 218 can be a lookup table or a dedicated memory space that can store business data associated with a given geographic location or geographic area that is collected or received by the processor 230. Examples of such business data can include product inventory level associated with a geographic area, financial data associated with a geographical area, operating hours of a store within a geographic area, employee data associated with a geographic area, customer data associated with a geographic area, and/or the like. The information stored in the business database 218 can be updated by the processor 230 whenever new data is available.

The operational database 220 can be a lookup table or a dedicated memory space that can store operational data associated with any mobile compute device from a set of mobile compute devices and/or a service in a given geographic location or a geographic area at a given or recurring time period. Such operational data can include, for example, device status, operating temperature of device, efficiency data, current load on device, errors, warnings, versions, number of connected users, and/or the like. The information stored in the operational database 220 can be updated by the processor 230 whenever new data is available.

The relevance database 222 can be a lookup table or a dedicated memory space that can store relevance scores or values. In some instances, such relevance scores or values can be representative of a measure of the relationship between the current demographic information for a given geographic location and the target demographic information for the given geographic location. In other instances, such relevance scores or values can be representative of a measure of the relationship between the current environmental information for a given geographic location and the target environmental information for a given geographic location. Hence, the closer the target DEBO information (or parameters) are to the current DEBO information, the higher the relevance is and thus the higher relevance score or relevance values becomes. In some instances, the relevance score can be a fractional number between 0 and 1, where a relevance score of 0 can represent no relationship between the target DEBO information and the current DEBO information, and a relevance score of 1 can represent substantially identical target DEBO information and current DEBO information (i.e., highly significant relationship between target DEBO information and current DEBO information). The relevance score or values are computed by the relevance calculation module 238 of the processor 230 and stored at the relevance database 222.

The advertisement database 224 can be a lookup table or a dedicated memory space that can store advertisement content (or advertisement campaigns) from different customers of the DEBO system. Such advertisement content can include, for example, image files, video files and/or audio (or sound) files. The customers of the DEBO system are advertisers that can be, for example, a business, an organization, an institution or an individual with the desire or intent to distribute relevant marketing information to a subset of the general public. In some instances, the customers (or advertisers) of the DEBO system can use an online portal (e.g., hosted at central server 200 and accessed via a compute device used by the advertiser) to upload an advertisement content, and can optionally define target DEBO parameters associated with the desired advertising content, and set a budget associated with the advertisement content. The advertisement campaign, defined as the advertising content and the associated target DEBO parameters and budget can be received at the central server 200 and stored in the advertisement database 224.

The award database 226 can be a lookup table or a dedicated memory space that can store units of awards rewarded to the user of the mobile compute device that is enrolled or registered in an advertisement reward program with the DEBO system. Such awards are rewarded to the user of a mobile compute device when the presence of the registered mobile compute device is detected within a pre-defined range of the given geographic location at the given time period. The award database 226 can also store an identifier of the mobile compute device that is registered in the advertisement reward program. Such device identifiers can be, for example, an internet protocol (IP) address of the mobile compute device, a media access control (MAC) address of the mobile compute device, and/or the like. Such award points can also be given to the user of the mobile compute device based on viewing advertisement contents within a pre-determined range of an advertisement display device associated with the remote media device. Such awarded points can be exchanged at a future point in time via a number of mechanisms for free products/services, discounts, upgrades or any other product or service associated with the advertisement reward program (i.e., a loyalty program).

The processor 230 can be a general purpose processor, a Field Programmable Gate Array (FPGA), an Application Specific Integrated Circuit (ASIC), a Digital Signal Processor (DSP), and/or the like. The processor 230 can run and/or execute applications, modules, processes and/or functions associated with the central server 200 and/or the DEBO system (e.g., DEBO system 100 in FIG. 1). The processor 230 includes a campaign module 232, a historical information aggregation module 234, a current information module 236, a relevance calculation module 238, an advertisement selection module 240, a fee generation module 242, and a reward module 244.

The campaign module 232 can be a hardware module(s) and/or software module(s) (stored in memory 210 and/or executed in processor 230) that can receive target demographic information for an advertisement campaign from a customer of the DEBO system (e.g., advertiser compute device 125 in FIG. 1). Such target demographic information can include, for example, a targeted age (or age range) for individuals identified as being within a predefined range of the geographic location during the current time period or recurrent time period, a targeted sex of the set of individuals, a targeted marital status of the set of individuals, a targeted income range of the set of individuals, a targeted interest of the set of individuals, and/or the like. For example, advertisement contents associated with luxury cars target individuals with high income (e.g., greater than $100,000/year), advertisements associated with shaving lotion target males over an age range (e.g., males older than fifteen year old), advertisements associated with golf clubs target individuals with a specific interest (i.e., golfers), etc.

The historical information aggregation module 234 can be a hardware module(s) and/or software module(s) (stored in memory 210 and/or executed in processor 230) that can receive and aggregate historical demographic information associated with a geographic location and a given time period or a recurring time period. Such historical demographic information can be accessed from the demographic database 212 of the central server 200, from a database(s) stored in the a third-party device that is operably coupled to the central server 200, from mobile compute devices within a predefined range of the geographic location during a given time period or a recurring time period.

The current information module 236 can be a hardware module(s) and/or software module(s) (stored in memory 210 and/or executed in processor 230) that can receive, based on the demographic information associated with a set of mobile compute devices within a predefined range of a geographic location during a current time period associated with a recurring time period, current demographic information associated with the geographic location and the current time period. Such current demographic information can include, for example, at least one of an age of each individual from a set of individuals identified as being within a predefined range of the geographic location during the current time period, a sex of each individual from the set of individuals, a physical attribute of each individual from the set of individuals, a marital status of each individual from the set of individuals, an income of each individual from the set of individuals, an address of each individual from the set of individuals, an employer of each individual from the set of individuals, or an interest of each individual from the set of individuals, and/or the like. In some instances, the current information module 236 can also store the current demographic information received from the demographic database 212.

The relevance calculation module 238 can be a hardware module(s) and/or software module(s) (stored in memory 210 and/or executed in processor 230) that is operatively coupled to at least the campaign module 232, the historical information aggregation module 234, and the current information module 236. The relevance calculation module 238 can calculate a relevance score (or relevance value) based on a measure of a relationship between the current demographic information, the historical demographic information, and/or the target demographic information for a given geographic location (or a geographic area) and/or a given time period or a recurring time period. For example, in some instances, the relevance score can be a fractional number between “0” and “1”, where “0” represents little and/or no relevance between the current demographic information, the historical demographic information, and/or the target demographic information and “1” represents high relevance between the current demographic information, the historical demographic information, and/or the target demographic information (e.g., substantially similar to current demographic information, historical demographic information, and target demographic information). In such instances, the current demographic information, the historical demographic information, and the target demographic information can be determined to be sufficiently relevant if the calculated relevance score is above a predetermined value or threshold (e.g., relevance score >0.5) or within a pre-determined range of values (e.g., 0.5<relevance score <1). Hence, the closer the target DEBO information (or parameters) are to the current DEBO information (or parameters) and/or the target DEBO information (or parameters), the higher the relevance is and thus the higher relevance score or relevance values becomes. Such relevance scores or relevance values calculated by the relevance calculation module 238 can be stored at the relevance database 222.

For example, if a target demographic for an advertisement campaign is males between the ages of 35-45, the current demographic information can be gathered and analyzed to calculate a relevance score. In such an example, the relevance score can be the percentage of individuals and/or monitored individuals that meet the target demographic information. Thus, if 50% of the monitored individuals present are male between the ages of 35-45, the relevance score can be 0.5. This score can be compared to a predetermined criterion (e.g., threshold, range, etc.) to determine whether to present the advertisement campaign.

In some instances, the relevance scores or values computed by the relevance calculation module 238 can be representative of a measure of the relationship between the current environmental information for a given geographic location and a given time period, the historical environmental information for the given geographic location and the given time period, and/or the target environmental information for the given geographic location and the given time period. For example, if a target environmental condition for a Caribbean vacation is below 32 degrees and snowing, the current environmental information can be gathered and analyzed to calculate a relevance score. In such an example, if the temperature is below 32 degrees and it is snowing, the relevance score can be 1.0. If, however, the temperature is below 32 degrees but sunny, the relevance score might drop to 0.8. Similarly, if the temperature is 40 degrees and cloudy, the relevance score might be 0.5. The further the current environmental information and/or historical environmental information deviates from the target environmental information, the relevance score can decrease. Such a relevance score can then be compared to a criterion (e.g., threshold, range, etc.) to determine whether to present the advertisement campaign.

In some embodiments, a single relevance score can be calculated based on both demographic information and environmental information. Thus, a high relevance score indicates that the target information (both demographic and environmental) is highly relevant to the current and/or historical information (both demographic and environmental). In such embodiments, the single score can be compared to a single criterion. In other embodiments, the scores can be separate and compared to different criteria (e.g., a first criterion for demographic relevance and a second criterion for environmental information).

The advertisement selection module 240 can be a hardware module(s) and/or software module(s) (stored in memory 210 and/or executed in processor 230) that is operatively coupled to at least the relevance calculation module 238. The advertisement selection module 240 can send, based on a relevance score or relevance value calculated by the relevance calculation module 238, a signal representing an instruction to present the advertisement content from an advertisement campaign to a device (e.g., RMD 126 in FIG. 1) associated with a given geographic location at a given time. The advertisement selection module 240 can also access the advertisement content or the set of advertisement contents with the highest relevance score from the relevance database 222. The advertisement selection module 240 can filter advertisement campaigns stored at the relevance database 222 based on the relevance score that relates the target DEBO information (or parameters) with the current DEBO information (or parameters) and/or historical DEBO information (or parameters). In some instances, the advertisement selection module 240 can then send a first set of advertisement contents with the highest relevance scores (i.e., if the current demographic information is substantially similar to the historical demographic information and/or the target demographic information) to the corresponding RMD associated with the given geographical location. Depending on their relevance score, such advertisements can displace other advertisements in, for example, the local advertisement registry or database of the RMD. In other instances, the advertisement selection module 240 can also send a second set of advertisement contents with the lowest relevance scores (i.e., if the current demographic information is not substantially similar to the historical demographic information and/or the target demographic information) to an RMD associated with the given geographical location.

The fee generation module 242 can be a hardware module(s) and/or software module(s) (stored in memory 210 and/or executed in processor 230) that can generate a fee amount for choosing the appropriate advertisement campaigns from the set of advertisement campaigns to present, for example, at an advertisement display device during the current time period and at a given geographic location based on target DEBO information (e.g., the number of pedestrians in the given geographic location at the given time period). The fee amount generated by the fee generation module 242 can be based on, for example, a budget associated with the presented advertisement content meeting a pre-defined criterion (e.g., being above a pre-defined dollar amount).

The reward module 244 can be a hardware module(s) and/or software module(s) (stored in memory 210 and/or executed in processor 230) that can reward a user associated with a mobile compute device from a set of mobile compute devices based on each mobile device from the set of mobile devices being within a pre-defined range of a given geographic location at the current time period that are, for example, enrolled in an advertisement reward program. In some instances, such rewards can include, points a user can use to purchase clothing at defined stores (e.g., Macy's, Banana Republic, Gap, etc.), points a user can use to purchase electronics at defined stores (e.g., Apple store, Best Buy, RadioShack, etc.), and/or the like.

The central server 200 also includes a communication interface 250, which can be operably coupled to the communication interfaces of multiple devices (e.g., remote sensory devices, mobile compute devices, advertiser compute devices, remote media devices, etc.). The communication interface 250 can include one or multiple wireless port(s) and/or wired ports. The wireless port(s) in the communication interface 250 can send and/or receive data units (e.g., data packets) via a variety of wireless communication protocols such as, for example, a Wi-Fi® protocol, a Worldwide Interoperability for Microwave Access (WiMAX) protocol, a cellular protocol (e.g., a third generation mobile telecommunications (3G) or a fourth generation mobile telecommunications (4G) protocol), 4G long term evolution (4G LTE) protocol), and/or the like. In some instances, the wired port(s) in the communication interface 250 can also send and/or receive data units via implementing a wired connection to multiple devices as described above. In such instances, the wired connections can be, for example, twisted-pair electrical signaling via electrical cables, fiber-optic signaling via fiber-optic cables, and/or the like.

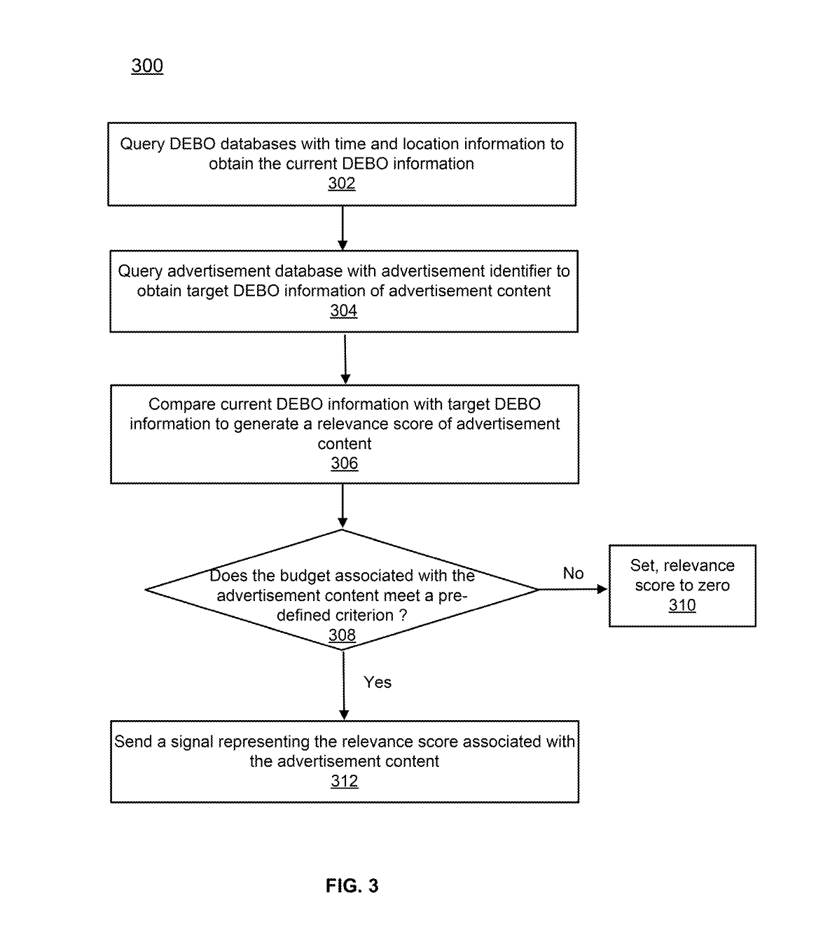

FIG. 3 is a flowchart illustrating a method for determining the relevance of a particular advertisement campaign to a given set of current DEBO information, according to an embodiment. The method 300 includes querying the DEBO databases using time (which could be past, current or in the future) and location information to obtain the current DEBO information (or parameters), at 302. As described above, the DEBO databases can include the demographic database, environmental database, business database and operational database that are stored in the central server. The querying of the DEBO databases can be performed by, for example, the relevance calculation module of the central server.

At 304, the advertisement database is queried with an advertisement identifier to obtain the target DEBO information (or parameters) associated with the advertisement content. The advertisement identifier can be for example, a serial number, a tag number, or any other unique identifier that can identify an advertising content from a set of advertising contents stored at the advertisement database. Additionally, in some instances, the advertisement identifier can have a set of header numbers that are unique to advertisement types such as, for example, video advertisements, audio advertisements, picture advertisements, and/or the like. The querying of the advertising database can be performed by, for example, the relevance calculation module of the central server.

At 306, the current DEBO information (or parameters) is compared with the target DEBO information (or parameters) in, for example, in the geographic location where the advertisement is targeted to present to generate or obtain a relevance score. As described above, the closer the target DEBO information (or parameters) are to the current DEBO information (or parameters), the higher the relevance is and thus the higher the relevance score. As described above, the generation of the relevance score can be performed by, for example, the relevance calculation module of the central server. It is to be noted that the relevance score is unique to each geographic location and at each given time period. Hence, for any single advertisement content, relevance scores differ for different geographic locations (e.g., as determined by the geographic location of the RMD) at a given point in time. Likewise, for any geographic location, relevance scores differ for different advertisement contents at any given point in time.

At 308, a check is performed by, for example, the relevance calculation module to determine if the budget associated with the advertisement content (or campaign) satisfies a pre-determined criterion such as, for example, the budget being greater than a pre-determined dollar amount for a given geographic location at a given time period. If the budget associated with the advertisement content does not satisfy the pre-determined criterion, the relevance score for that advertisement is set to zero by, for example, the relevance calculation module, at 310. If the budget associated with the advertisement content satisfies the pre-determined criterion, a signal representing the relevance score associated with the advertisement content for a given geographic area and a given time period is sent by, for example, the relevance calculation module to, for example, the advertisement selection module, at 312.

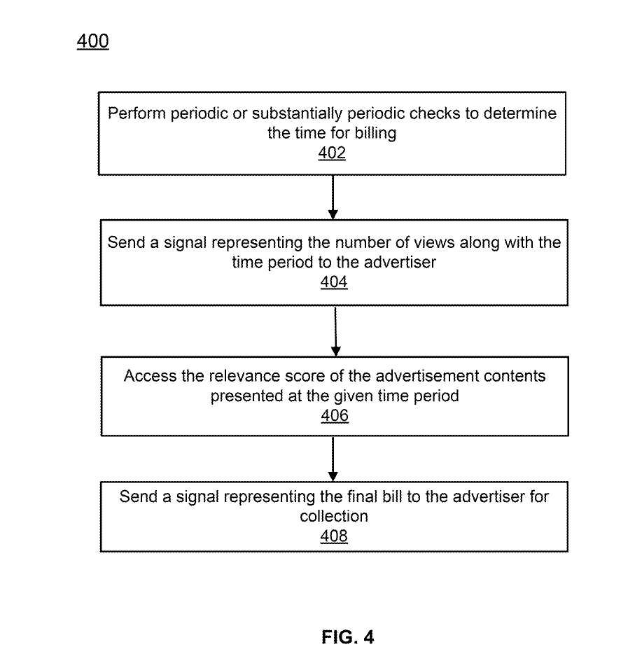

FIG. 4 is a flowchart illustrating a method for charging an advertiser for presenting advertisement contents at a given geographical location per billing cycle, according to an embodiment. As used herein, the advertiser can be, for example, a business, an organization, an institution or an individual with the desire or intent to distribute relevant marketing information to a subset of the general public. The advertiser can be associated with an advertiser compute device (e.g., advertiser compute device 125 in FIG. 1). In some instances, the advertiser can define an advertisement campaign by uploading the advertisement content to the central server, defining the associated target DEBO information (or parameters), assigning a budget, and then registering the advertising campaign with the central server. The online portal (e.g., hosted at central server and accessed via an advertiser compute device) is defined as the mechanism for defining or editing the advertisement campaign.

The method 400 includes performing repeated, periodic or substantially periodic checks to determine the time for billing by, for example, the fee generation module of the central server, at 402. A timer loop sequence can be used by the fee generation module to repeatedly, periodically or substantially periodically check for the time of billing. When the end of the billing period is detected, a signal representing the number of views along with a time period can be sent from, for example, the central server to, for example, the advertiser compute device, at 404. The number of views can be calculated by analyzing historical DEBO information that can include the number of detected pedestrians and/or the number of detected vehicles within a pre-defined range of the geographic location during the billing period (i.e., at the time period when the advertisement content was presented).

At 406, the relevance score of the advertisement contents presented during the billing period can be accessed by, for example, the fee generation module from, for example, the relevance calculation module. At 408, the number of views for each advertisement content presented, the relevance score for each presented advertisement, the optimal rate, projected price for viewers, and the actual rate are calculated to generate a final bill, and a signal representing the final bill is sent from, for example, the fee generation module of the central server to, for example, the advertiser compute device associated with the advertiser for collection.

Additionally, the advertiser can also use the online portal at any point in time to check on the status of an advertisement campaign. Some of the parameters of the advertisement campaign that can be monitored via the online portal can include, for example, current balance of the budget associated with an advertising entity, numbers of views over a time period, average relevance between current DEBO information, historical DEBO information and target DEBO information, collected demographic information, business vs. advertising results, and/or the like. When the end of the billing period is reached, the advertiser can send a request signal to the central server that can request for the number of views generated for the advertising content presented at the given geographic location in the billing time period. In some instances, the central server can estimate the average number of views of vehicles and/or pedestrians using, for example, cell tower triangulation methods, where the viewer count can be estimated by, for example, the number of vehicles and/or the number of pedestrians in a broader geographical area than the target geographical location (or area). Such figures can be summed to calculate the total views and multiplied by the fee charged per view to generate a final pricing that is then sent to the advertiser.

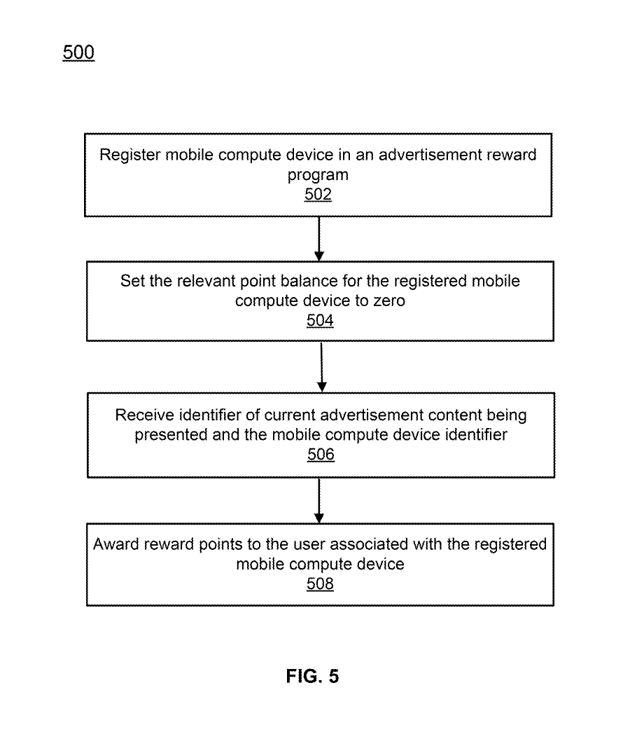

FIG. 5 is a flowchart illustrating a method for providing a reward to a user of a mobile compute device for being within a pre-defined range of a given geographic location, according to an embodiment. The method 500 includes registering a mobile compute device in an advertisement reward program at, for example, the reward module of the central server, at 502. As described above, the mobile compute device can be, for example, smart phones, cellular phones, laptop computers, tablets, desktop computers, web-enabled appliances and clothing, vehicles with Internet capabilities, and/or the like. Registering a mobile compute device can include, for example, recording the IP address of the mobile compute device, the MAC address of the mobile compute device or any other identifier unique to the mobile compute device in a database in the central server. The registration can be performed via a web portal or by automatic or manual data entry. The registration can also take place as part of another process such as, for example, via signing up for a corporate loyalty card.

At 504, the point balance for the registered mobile compute device is set to zero. The point balance is an identifier that tracks the units of reward awarded to the user of the mobile compute device and can be stored at a database in the central server. At 506, an identifier of the current advertisement content being presented at a specific geographical location at the current time period and the mobile compute device identifier is received at, for example, the reward module. The presence of the registered mobile compute device within a pre-defined range of the given geographic location at the current time period is registered by the remote media device associated with the given geographical location. At 508, a set number of points (i.e., pre-determined by the advertiser) can be awarded by, for example, the reward module of the central server to the user associated with the registered mobile compute device. Such award points are also given to the user of the mobile compute device based on viewing advertisements within a pre-determined range of an advertisement display device associated with the remote media device. Such awarded points can be exchanged at a future point in time via a number of mechanisms for free products/services, discounts, upgrades or any other product or service associated with the advertisement reward program (i.e., a loyalty program).

In other configurations, an alternate method for awarding points to users of mobile compute devices can be implemented that uses the user's mobile compute device without the need for an RMD to detect the location of mobile compute devices. In such configurations, a mobile compute device regularly calculates or detects its current location information using any number of location services such as but not limited to GPS, Wi-Fi®-based geo-location services and/or the like. This location information is regularly or substantially regularly sent to the central server, where the current location information is analyzed to determine if the current location is within pre-defined range of the given geographic location at the current time period (e.g., by matching the current location co-ordinates of the mobile compute device to the location co-ordinates of a given advertising display device). If this is the case, the advertisement database in the central server can be checked to determine the particular advertisement content that is being presented at the given advertising display device and the set number of points are then awarded to the user of the mobile compute device. Reward points may be awarded either by the central server and/or by the advertiser in the form of, for example, a discount or coupon sent directly to the user's mobile compute device and/or the users address and/or email.

In some instances, the advertiser associated with the advertiser compute device can upload an advertisement content (media file) such as, for example, an image file or a video file to the central server via the online portal. In such instances, the advertiser can verify the resolution and/or format of the advertisement content (media file), and optionally can opt to implement a number of post-processing techniques on the advertisement content (media file). Such post-processing techniques (or modifications) can include, for example, file cropping, or color correcting the contents of the advertisement content (media file). Subsequently, the advertiser may also be able to view a sample of post-processed advertisement media file to determine the efficacy of improving the quality of the advertisement content by using the post-processing techniques. In such instances, the advertiser can then proceed to define the target DEBO information associated with the advertisement content (e.g., the target geographical location coordinates), and add a budget to define the advertisement campaign. The advertisement campaign can then be uploaded to, for example, the advertisement database of the central server. The target geographical location for presentation of the advertisement content can, in some instances, can be defined via cellular triangulation methods and/or by estimation of the geographical location of existing RMDs and/or advertisement display devices.

In some configurations, the advertiser associated with the advertiser compute device can upload radio advertisement campaigns for presentation on one or multiple advertisement display devices in a given geographic location at a given time period. Referring to FIG. 1, in such instances, the advertiser can define an advertisement campaign by uploading the radio advertisement content, setting the target DEBO parameters for the advertisement content, adding a budget, and then registering the advertisement campaign with the central server. In such instances, the RMD can be part of, or in close proximity to an advertisement display device that in this case can be a radio device (e.g., satellite radio, amplitude-modulated (AM) radio, frequency-modulated (FM) radio, shortwave radio, etc.). In such configurations, the RMD can have a connection to the Internet via a number of wired or wireless protocols (e.g., Ethernet, Wi-Fi®, Bluetooth®, third generation (3G), fourth generation (4G), long term evolution (LTE)®, etc.). The RMD can also include the radio owner's demographic data such as, for example, the target demographic information or data for advertisements. In such configurations, the RMD can periodically or substantially periodically perform checks to determine if a commercial break or radio station's regular broadcast in occurring in the current time period. In such instances, while the regular radio broadcast is taking place, the RMD passes the feed from the radio station. When a break in the radio station's broadcast is detected, however, the radio feed can be switched to a feed from the local advertisement database or registry in the RMD, which is pre-loaded with relevant radio advertisement content from the central server. In such configurations, as soon as the commercial break is over on the radio station (i.e., advertisement display device), the radio advertisement content transmission is stopped and the regular radio feed is resumed. This leads to a system where the radio listeners can listen to the same music or program, but different, targeted, relevant advertisements.

In some configurations, dynamic advertising content (e.g., content updated in a substantially real-time manner such as a news ticker, an indication of stock prices, an indication of current sports scores, etc.) can be used in conjunction with an advertisement campaign, where the advertising content is loaded into the advertisement display device from a webserver. In such configurations, advertisers associated with an advertiser compute device can provide (in either audio or video form) advertising content that is dynamic in nature (e.g., remains current and/or up-to-date).

In such configurations, an advertiser can upload dynamic content to a local or cloud-based web server and/or file server, and supply an IP address (or other address or identifier used to retrieve the content) of the local or cloud-based web server and/or file server to the web portal associated with the central server. In such configurations, the advertiser can also define the resolution of the advertising content and optionally can implement post-processing techniques on the advertising content such as, for example, file cropping, filtering, color scale modifications, etc. The advertiser can also preview the post-processed advertising content to confirm the efficacy of the post-processing techniques to improve the quality of the post-processed advertising content. Subsequently, the advertiser can add the target DEBO parameters to the advertising content and also add a budget associated with the advertising content to define an advertisement campaign, and upload the advertisement campaign to the central server.

Once such an advertisement campaign is selected by the central server to be presented at an advertisement display device located in a given geographic location at a given time period (based on the calculated relevance score that relates, for example, the current DEBO parameters with the target DEBO parameters) and sent to the appropriate RMD to be presented at the given advertisement display device, a determination can be made at the RMD to identify whether the advertisement campaign is dynamic. Upon confirmation of the dynamic quality of the advertisement campaign, the advertisement campaign can be streamed from the local or cloud-based web server and/or file server storing the content and into a local buffer in the RMD and prepared for output. Once the advertisement campaign is determined as relevant in the RMD for a given geographical location and at a given time period, the advertisement campaign can be sent from the buffer of the RMD to the advertisement display device to be presented. If the advertisement campaign is selected again for presentation at a future time period, the advertisement campaign is re-buffered to remain current. Similarly stated, each time an RMD determines to present a dynamic advertisement, the RMD can ensure that the most up-to-date content stored at the local or cloud-based web server and/or file server is retrieved and presented.

In other embodiments, rather than the RMD retrieving or pulling the content from the local or cloud-based web server and/or file server, the content can be pushed to the RMD. In such embodiments, when a change is made to the content, the local or cloud-based web server and/or file server can send an indication of the change to the RMD such that the RMD can display the updated content. For example, if breaking news occurs, the RMD can receive an indication of the breaking news and can modify the displayed advertisement. For another example, as a baseball score changes, the RMD can receive an indication of the change and can present the updated score.

In still other embodiments, a dynamic advertisement can interrupt and/or be displayed instead of another relevant advertisement. For example, if an RMD currently displaying an advertisement receives an indication of the conclusion of a baseball game, the RMD can retrieve a dynamic advertisement associated with the local baseball team and present the advertisement with the final score instead of the advertisement already being displayed. Similarly stated, the RMD can interrupt the already displayed advertisement to display a dynamic advertisement associated with a current event when the RMD receives an indication of that current event. In such embodiments, the RMD can produce relevant and/or dynamic advertisements that correspond and/or relate to current events in the area.

In some configurations, a self-optimizing advertisement campaign can be implemented with a DEBO system (e.g., DEBO system 100 in FIG. 1) that can use an advertiser's sales and performance information (e.g., stored in a business database located in the advertiser compute device) to improve or optimize the target DEBO information (or parameters) of the advertisement campaign associated with the advertiser. In such configurations, an operational link is established between the business database located in the advertiser compute device and the central server. In such configurations, the central server can access the contents to the business database of the advertiser compute device to monitor the business effect of presenting an advertisement content (associated with an advertisement campaign) and automatically improve or optimize the target DEBO information (or parameters) to improve or maximize the efficacy of presenting the advertisement contents at the given geographic location and the given time period. Such a feedback loop can be established or optimized to maximize or minimize one or a number of different business parameters such as, for example, sales, profit, volume of sales, and/or the like.

In some configurations, a playlist of future advertisement campaigns can be predicted ahead of a given time period and sent to an advertisement display device at a given geographic location for future play. Such a mode of operation can take place in some instances when current and future DEBO information may not be available on the DEBO databases stored in the central server, and such future DEBO information can be predicted and/or estimated ahead of time to determine which advertising campaigns should be sent and/or buffered to the RMD ahead of a given time period. In such configurations, the central server first determines the future time period for which the DEBO information is to be predicted. Using stored historical DEBO information and the desired future time period, the central server can use any one of a number of predictive analytic techniques and models (e.g., linear regression, discrete choice, logistic regression, probit regression, logit regression, time series, regression trees, and/or the like) to predict DEBO information for the future time period, along with an estimation of the accuracy of the prediction. The predicted DEBO information is used as the basis to compare with the target DEBO information for the advertisement campaigns stored in the campaign database of the central server to generate individual relevance scores. The most relevant advertisement campaigns are then sent to the RMD with a timestamp that indicates the given future time period. After passage of time, when the current time equals the given future time, such advertisement contents associated with the advertisement campaigns that were sent ahead of the new current time (i.e., old future time) are presented on the advertisement display device at the given geographical location given the current DEBO information (or parameters) are substantially similar to the DEBO information (or parameters) predicted by the predictive algorithm (e.g., implemented by a prediction module in the central server).

In some configurations, advertisers associated with advertiser compute devices can use the DEBO databases stored in the central server (e.g., DEBO databases 212-220 in FIG. 2) to view and/or analyze the advertisement campaign feedback after a period of using the DEBO system to present advertisement contents. Such feedback can be in the form of demographics or the number of viewers that were exposed to an advertisement content presented at a given geographical location and a given time period as well as the performance of the advertisement campaign. The advertiser can use the online portal associated with the central server to request the DEBO information associated with their advertisement campaign. In such configurations, a query for every timestamp and geographic location where an associated advertisement campaign was presented is performed. The results of such a query can then be used to search and access the DEBO information recorded at that given time period. Such DEBO information can then be formatted (if needed) in a number of ways such as, for example, in tables, charts, graphs, infographics, and/or the like. Such formatted DEBO information can be returned as a result of the query through the web portal to the advertiser compute device for further analysis. Such data might include views of the ads, number of pedestrians vs. vehicles, average age, sex, marital status, weather conditions, associated sales of a product or item, and/or the like.

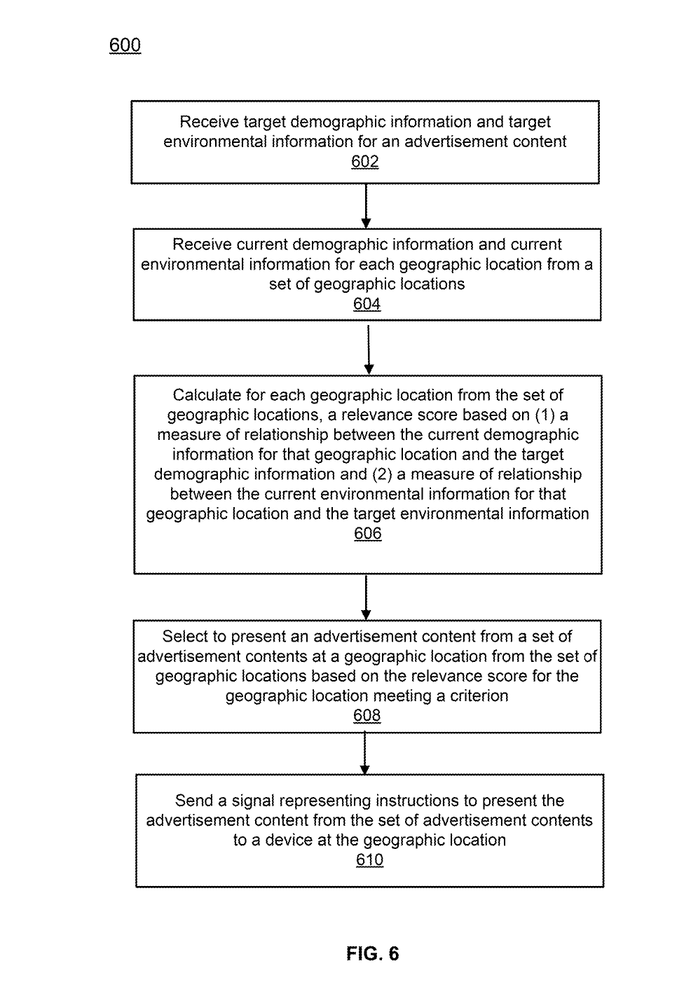

FIG. 6 is flowchart illustrating a method for calculating the relevance score between current DEBO information and target DEBO information to present advertisement content at a given geographic location, according to an embodiment. The method 600 includes receiving target demographic information and target environmental information for advertisement content at, for example, a central server, at 602. As described above the target demographic information and target environmental information can be sent to the central server from, for example, an advertiser compute device. As described above, such target demographic information can include, for example, a targeted age (or age range) for individuals identified as being within a predefined range of the geographic location during the current time period or recurrent time period, a targeted sex of the set of individuals, a targeted marital status of the set of individuals, a targeted income range of the set of individuals, a targeted interest of the set of individuals, and/or the like. As described above, target environmental information can include, for example, a target weather at the geographical location during the current time period, a target ambient light level at the geographical location at the current time period, a target number of individuals within a pre-defined range of the geographical location during the current time period, a target number of automobiles within a pre-defined range of the geographical location during the current time period, a target number of pedestrians within a pre-defined range of the geographical location during the current time period, a target allergen level at the geographic location during the current time period, a target pollution level at the geographic location during the current time period, a target noise level at the geographic location during the current time period, and/or the like.

At 604, the current demographic information and the current environmental information for each geographic location from the set of geographical location are received at, for example, the central server. As described above, the central server can be, for example, a computer server that can include a storage segment and computational segment, where several sub-systems or modules are located to accomplish a number of tasks such as, for example, analysis of data generated by the underlying data platform, prediction of current DEBO information, registering of advertisement contents, evaluation of advertisement contents or relevance at certain geographic locations at specific times, distributing advertisements to “real-world” advertisement display devices, accounting functions, and/or the like.

At 606, a relevance score is calculated for each geographic location from the set of geographic locations based on a measure of relationship between the current demographic information for that geographic location and the target geographic location, and a measure of relationship between the current environmental information for that geographic location and the target environmental information at, for example, the relevance calculation module of the central server. As described above, the relevance score can be representative of a measure of the relationship between the current environmental (or demographic) information for a given geographic location and the target environmental (or demographic) information for a given geographic location. Hence, the closer the target DEBO information is to the current DEBO information, the higher the relevance is and thus the higher relevance score calculated becomes. In some instances, the relevance score can be a fractional number between 0 and 1, where a relevance score of 0 can represent no relationship between the target DEBO information and the current DEBO information, and a relevance score of 1 can represent substantially correlated target DEBO information and current DEBO information (e.g., highly significant relationship between target DEBO information and current DEBO information).

At 608, advertisement content from a set of advertisement contents is selected to be presented at a geographic location from the set of geographic locations based on the relevance score for that geographic location meeting a criterion. As described above, the selection of the advertisement content for presentation at a geographic location from the set of geographic locations can be performed at, for example, the advertisement selection module of the central server. The criterion(ia) can be, for example, the relevance score that relates the current demographic information for that geographic location to the target geographic location and/or relates the current environmental information for that geographic location to the target environmental information exceeding a pre-determined value. As described above, an additional criterion for selection of an advertisement content for presentation at a geographic location can be if the budget associated for the advertisement content has funds greater than a pre-determined dollar amount for a given geographic location at the given time period.

At 610, a signal representing instructions to present the selected advertisement content from the set of advertisement contents is sent from, for example, the central server to, for example, a remote media device associated with the geographic location. As described above, the remote media device is a device that can facilitate or present advertisement contents on any kind of advertisement display devices. In some instances, the remote media device can directly output or present their advertisement content through a set of protocols, such as High-Definition Multimedia Interface (HDMI)®, Video Graphics Array (VGA), Digital Visual Interface (DVI), Ethernet, 3.5 mm jack, stereo connection, mono connection, and/or the like. In other instances, the remote media device can be operably coupled to one or multiple advertisement display devices and can send a signal to present the advertisement content to such advertisement display device(s) that can be, for example, digital advertisement billboards, posters, and screens that use light-emitting diode (LED) screen-based, liquid crystal display (LCD) screen-based, media and/or the like.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

What is claimed is:

1. A non-transitory processor-readable medium storing code representing instructions to be executed by a processor, the code comprising code to cause the processor to:
receive historical demographic information associated with a geographic location and a recurring time period, and historical environmental information associated with the geographic location and the recurring time period;
select a first plurality of advertisements for the geographic location and the recurring time period based on the historical demographic information and the historical environmental information;
receive current demographic information associated with the geographic location and a current time period that is associated with the recurring time period, and current environmental information associated with the geographic location and the current time period;
send an instruction to present the first plurality of advertisements to a device at the geographic location and during the current time period if (1) the current demographic information is substantially similar to the historical demographic information and (2) the current environmental information is substantially similar to the historical environmental information; and
send an instruction to present a second plurality of advertisements to a device at the geographic location and during the current time period if (1) the current demographic information is not substantially similar to the historical demographic information or (2) the current environmental information is not substantially similar to the historical environmental information.

2. The non-transitory processor-readable medium of claim 1, wherein the code to cause the processor to select includes code to cause the processor to select the first plurality of advertisements based on (1) target demographic information for each advertisement from the first plurality of advertisements being substantially similar to the historical demographic information associated with the geographic location and the recurring time period, and (2) target environmental information for each advertisement from the first plurality of advertisements being substantially similar to the historical environmental information associated with the geographic location and the recurring time period.

3. The non-transitory processor-readable medium of claim 1, wherein the current demographic information includes at least one of an age of each individual from a set of individuals identified as being within a predefined range of the geographic location during the current time period, a sex of each individual from the set of individuals, a physical attribute of each individual from the set of individuals, a marital status of each individual from the set of individuals, an income of each individual from the set of individuals, an address of each individual from the set of individuals, an employer of each individual from the set of individuals, or an interest of each individual from the set of individuals.

4. The non-transitory processor-readable medium of claim 1, wherein the current environmental information includes at least one of weather at the geographic location during the current time period, an ambient light level at the geographic location during the current time period, a number of individuals within a predefined range of the geographic location during the current time period, a number of automobiles within the predefined range of the geographic location during the current time period, a number of pedestrians within the predefined range of the geographic location during the current time period, an allergen level at the geographic location during the current time period, a pollution level at the geographic location during the current time period, or a noise level at the geographic location during the current time period.

5. The non-transitory processor-readable medium of claim 1, wherein the code to cause the processor to select includes code to cause the processor to select the first plurality of advertisements based on a budget associated with each advertisement from the first plurality of advertisements meeting a criterion.

6. The non-transitory processor-readable medium of claim 1, wherein the current demographic information includes demographic information associated with a user of each mobile compute device from a set of mobile compute devices within a predefined range of the geographic location during the current time period.

7. The non-transitory processor-readable medium of claim 1, wherein the current environmental information includes a number of pedestrians within a predefined range of the geographic location during the current time period, the code further comprising code to cause the processor to:
generate a fee amount for displaying an advertisement from the first plurality of advertisements during the current time period and at the geographic location based at least in part on the number of pedestrians.

8. A non-transitory processor-readable medium storing code representing instructions to be executed by a processor, the code comprising code to cause the processor to:
receive target demographic information and target environmental information for an advertisement campaign;
receive current demographic information and current environmental information for each geographic location from a plurality of geographic locations;
calculate, for each geographic location from the plurality of geographic locations, a relevance score based on (1) a measure of relationship between the current demographic information for that geographic location and the target demographic information and (2) a measure of relationship between the current environmental information for that geographic location and the target environmental information;
select to display an advertisement from the advertisement campaign at a geographic location from the plurality of geographic locations based on the relevance score for the geographic location meeting a criterion; and
send an instruction to display the advertisement from the advertisement campaign to a device at the geographic location.

9. The non-transitory processor-readable medium of claim 8, wherein the current demographic information includes at least one of an age of each individual from a set of individuals identified as being within a predefined range of the geographic location during a current time period, a sex of each individual from the set of individuals, a physical attribute of each individual from the set of individuals, a marital status of each individual from the set of individuals, an income of each individual from the set of individuals, an address of each individual from the set of individuals, an employer of each individual from the set of individuals, or an interest of each individual from the set of individuals.

10. The non-transitory processor-readable medium of claim 8, wherein the current environmental information includes at least one of weather at the geographic location during a current time period, an ambient light level at the geographic location during the current time period, a number of individuals within a predefined range of the geographic location during the current time period, a number of automobiles within the predefined range of the geographic location during the current time period, a number of pedestrians within the predefined range of the geographic location during the current time period, an allergen level at the geographic location during the current time period, a pollution level at the geographic location during the current time period, or a noise level at the geographic location during the current time period.

11. The non-transitory processor-readable medium of claim 8, wherein the criterion is a first criterion, the code to cause the processor to select includes code to cause the processor to select to display the advertisement from the advertisement campaign based on a budget associated with the advertisement campaign meeting a second criterion.

12. The non-transitory processor-readable medium of claim 8, wherein the current demographic information includes demographic information associated with a user of each mobile compute device from a set of mobile compute devices within a predefined range of the geographic location during a time period.

13. The non-transitory processor-readable medium of claim 8, wherein the current environmental information includes a number of pedestrians within a predefined range of the geographic location during a time period, the code further comprising code to cause the processor to:
generate a fee amount for displaying the advertisement from the advertisement campaign during the time period and at the geographic location based at least in part on the number of pedestrians.

14. The non-transitory processor-readable medium of claim 8, wherein the code to cause the processor to select includes code to cause the processor to select to display the advertisement based on an indication of a frequency of the advertisement being displayed at the geographic location.

15. An apparatus, comprising:
a campaign module implemented in at least one of a memory or a processing device, the campaign module configured to receive target demographic information for an advertisement campaign;
a historical information aggregation module configured to receive and aggregate historical demographic information associated with a geographic location and a recurring time period;
a current information module configured to receive, based on demographic information associated with a set of mobile compute devices within a predefined range of the geographic location during a current time period associated with the recurring time period, current demographic information associated with the geographic location and the current time period;
a relevance calculation module operatively coupled to the campaign module, the historical information aggregation module, and the current information module, the relevance calculation module configured to calculate a relevance score based on a measure of relationship between (1) the current demographic information and the historical demographic information for the geographic location and the recurring time period, and (2) the target demographic information; and
an advertisement selection module operatively coupled to the relevance calculation module, the advertisement selection module configured to send, based on the relevance score, an instruction to display an advertisement from the advertisement campaign to a device at the geographic location.

16. The apparatus of claim 15, wherein the campaign module is configured to receive target environmental information for an advertisement campaign, the current information module is configured to receive current environmental information associated with the geographic location and the current time period, the relevance calculation module configured to calculate the relevance score based on a measure of relationship between the current environmental information and the target environmental information.

17. The apparatus of claim 15, wherein the current demographic information includes at least one of an age of a user of each mobile compute device from the set of mobile compute devices, a sex of a user of each mobile compute device from the set of mobile compute devices, a physical attribute of a user of each mobile compute device from the set of mobile compute devices, a marital status of a user of each mobile compute device from the set of mobile compute devices, an income of a user of each mobile compute device from the set of mobile compute devices, an address of a user of each mobile compute device from the set of mobile compute devices, an employer of a user of each mobile compute device from the set of mobile compute devices, or an interest of a user of each mobile compute device from the set of mobile compute devices.

18. The apparatus of claim 15, wherein the advertisement selection module is configured to send the instruction to display the advertisement based on a budget associated with the advertisement meeting a criterion.

19. The apparatus of claim 15, wherein the current information module is configured to receive an indication of a number of pedestrians within the predefined range of the geographic location during the current time period, the apparatus further comprising:
a fee generation module configured to generate a fee amount for displaying the advertisement from the advertisement campaign during the current time period and at the geographic location based at least in part on the number of pedestrians.

20. The apparatus of claim 15, further comprising:
a reward module configured to provide a reward to a user associated with each mobile compute device from the set of mobile compute devices based on each mobile compute device from the set of mobile compute devices being within the predefined range of the geographic location at the current time period and enrolled in an advertisement reward program.
